(19) United States
(12) Patent Application Publication
(10) Pub. No.: US 2025/0112310 A1
(43) Pub. Date: Apr. 3, 2025

(54) MULTILAYER BATTERY PACK INSULATOR

(71) Applicant: FEDERAL-MOGUL POWERTRAIN LLC, Northville, MI (US)

(72) Inventors: Julian Francesco Picofazzi, Plymouth Meeting, PA (US); Zobar Hassan, Elmont, NY (US); Kamel Fennell, Plymouth Meeting, PA (US); Jordan Zachary Boatwright, York, PA (US); Shannon Jade Notaro, Clifton, NJ (US); Hicham Rokni, Clifton, NJ (US)

(21) Appl. No.: 18/898,496

(22) Filed: Sep. 26, 2024

Related U.S. Application Data
(60) Provisional application No. 63/541,775, filed on Sep. 29, 2023.

(51) Int. Cl. H01M 50/231; B32B 5/02; B32B 5/06; B32B 5/26; B32B 37/24; B32B 38/00; H01M 50/222; H01M 50/227; H01M 50/229; H01M 50/24; H01M 50/249

(52) U.S. Cl. CPC H01M 50/231; B32B 5/024; B32B 5/026; B32B 5/073; B32B 5/26; B32B 5/263; B32B 5/2795; B32B 37/24; B32B 38/0004; H01M 50/222; H01M 50/227; H01M 50/229; H01M 50/24; H01M 50/249; B32B 2037/243; B32B 2038/008; B32B 2250/03; B32B 2250/20; B32B 2255/02; B32B 2255/26; B32B 2262/101; B32B 2262/105; B32B 2264/1026; B32B 2305/182; B32B 2305/188; B32B 2307/304; B32B 2307/3065; B32B 2307/718; B32B 2315/02; B32B 2315/085; B32B 2315/10; B32B 2383/00; B32B 2457/10; B32B 2605/08; H01M 2220/20

(57) ABSTRACT

A flexible multilayer battery pack insulator for an electric vehicle having a multilayer wall including a plurality of layers. The plurality of layers includes an inner layer of mineral material having an inner surface and an outer surface, and an outer layer of mineral material having an inner surface and an outer surface. A flame-resistant coating, including silicone and mica, bonded to at least one of the plurality of layers. An adhesive layer bonded to the outer surface of the inner layer, and at least one filament fixing the plurality of layers to one another.

### CROSS-REFERENCE TO RELATED APPLICATION

This application claims the benefit of U.S. Provisional Application Ser. No. 63/541,775, filed Sep. 29, 2023, which is incorporated herein by reference in its entirety.

### BACKGROUND OF THE INVENTION

### 1. Technical Field

This invention relates generally to thermal insulators, and more particularly to multilayer thermal insulators for inhibiting flame propagation from a battery pack of an electric vehicle.

### 2. Related Art

It is known to contain or shield battery packs, including those used in electric vehicle applications, in thermal insulation. A common material used to form such thermal insulation is a fiberglass fabric. Although the fiberglass fabric insulation provides an acceptable level of protection against contamination and environmental temperatures during normal use, the fiberglass fabric insulation does not provide a desired level of protection against flame propagation, such as may be experienced in a thermal runaway condition of one or more cells of the electric vehicle battery pack. The fiberglass insulator can result in a thermal runaway condition originating in any one of the cells of the battery pack, such that flame propagates outwardly from the battery pack in less than 5 minutes at a temperature of 1000° C.

It is desired to provide a thermal insulation that inhibits the propagation of flame outwardly from a battery case of a battery pack for 10 minutes or more at a temperature of 800° C.-1500° C.

### SUMMARY OF THE INVENTION

It is an object of the present disclosure to provide a multilayer material for use with an electric vehicle battery pack that addresses at least the desire to inhibit the propagation of flame from the battery pack for 10 minutes or more at a temperature of 800-1500° C.

It is a further object of the present disclosure to provide a multilayer material for use with an electric vehicle battery pack that minimizes the amount of flame fuel present within the multilayer material.

It is a further object of the present disclosure to provide a multilayer material for use with an electric vehicle battery pack that is flexible, lightweight, has a thin, low profile to minimize the amount of space occupied by the thermal insulator, and is economical in manufacture and in use.

One aspect of the invention provides a flexible multilayer battery pack insulator for an electric vehicle including: a multilayer wall having a plurality of layers including an inner layer of mineral material having an inner surface and an outer surface, and an outer layer of mineral material having an inner surface and an outer surface. At least one flame-resistant coating, including silicone and mica, bonded to at least one of the plurality of layers. An adhesive layer is bonded to the outer surface of the outer layer, and at least one filament fixes the plurality of layers to one another.

Another aspect of the invention provides a flexible multilayer battery pack insulator for an electric vehicle. The insulator has an inner layer of mineral material. The inner layer has an outer surface and an inner surface. A first flame-resistant coating is bonded to the inner surface of the inner layer. The insulator further includes an intermediate layer of mineral material and an outer layer of mineral material. The intermediate layer is disposed between the outer layer and the inner layer. A pressure-sensitive adhesive is bonded to the outer layer. The pressure-sensitive adhesive faces away from the intermediate layer. The insulator has at least one filament fixing the outer layer, the intermediate layer, and the inner layer to one another.

In accordance with another aspect of the invention, the interlaced mineral material can be provided as mineral yarns interlaced with one another.

In accordance with another aspect of the invention, the interlaced mineral yarns are silica.

In accordance with another aspect of the invention, the interlaced mineral yarns are woven or knitted.

In accordance with another aspect of the invention, the first flame-resistant coating is a silicone-based coating.

In accordance with another aspect of the invention, the first flame-resistant coating includes silicone and mica.

In accordance with another aspect of the invention, the mica ranges between 1-35% by weight of the first flame-resistant coating.

In accordance with another aspect of the invention, the outer layer, the intermediate layer, and the inner layer are not bonded to one another with an adhesive material.

In accordance with another aspect of the invention, the pressure-sensitive adhesive layer is the only adhesive layer of the multilayer wall.

In accordance with another aspect of the invention, the flexible multilayer wall prevents flame propagation when exposed to temperatures between about 800-1500° C. for a continuous duration of 10 minutes.

In accordance with another aspect of the invention, the multilayer wall has a thickness between 1.5 mm and 2.5 mm.

In accordance with another aspect of the invention, a flexible multilayer battery pack insulator for an electric vehicle, comprises, a multilayer wall including: a plurality of layers of interlaced mineral material. The plurality of layers include an outer layer having a first exposed, outwardly facing surface and an inner layer having a second exposed, inwardly facing surface. A flame-resistant coating is bonded to at least one of the plurality of layers. A pressure-sensitive adhesive is bonded to the first exposed, outwardly facing surface. At least one filament fixes the plurality of layers to one another.

In accordance with another aspect of the invention, a method of constructing a flexible multilayer battery pack insulator includes: interlacing mineral material to form an inner layer having an outer surface and an inner surface; bonding a first flame-resistant coating to the inner surface of the inner layer; interlacing mineral material to form an intermediate layer; interlacing mineral material to form an outer layer; arranging the intermediate layer between the inner layer and the outer layer; stitching at least one filament and fixing the inner layer, the intermediate layer, and the outer layer to one another to form a multilayer wall; bonding a pressure-sensitive adhesive to the outer layer; and cutting the multilayer wall to size.

In accordance with another aspect of the invention, the method further includes leaving the outer layer, the intermediate layer, and the inner layer in detached relation from one another other than where stitched together by the at least one filament.

In accordance with another aspect of the invention, the method further includes using a mineral yarn coated with a fire-resistant coating for the at least one filament.

In accordance with another aspect of the invention, the method further includes using polytetrafluoroethylene for the fire-resistant coating.

In accordance with another aspect of the invention, the method further includes using fiberglass or silica for the mineral yarn of the at least one filament.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a schematic perspective view of an electric motor vehicle having a battery pack with multilayer thermal insulators constructed in accordance with an aspect of the invention;

FIG. 2 is a schematic cross-sectional side view taken generally along the line 2-2 of FIG. 3 of a multilayer thermal insulator in accordance with a non-limiting embodiment of the disclosure;

FIG. 3 is a fragmentary perspective view of the multilayer thermal insulator in accordance with a non-limiting embodiment of the disclosure; and

FIG. 4 is an exploded view similar of the multilayer thermal insulator of FIG. 3.

### DETAILED DESCRIPTION OF PREFERRED EMBODIMENTS

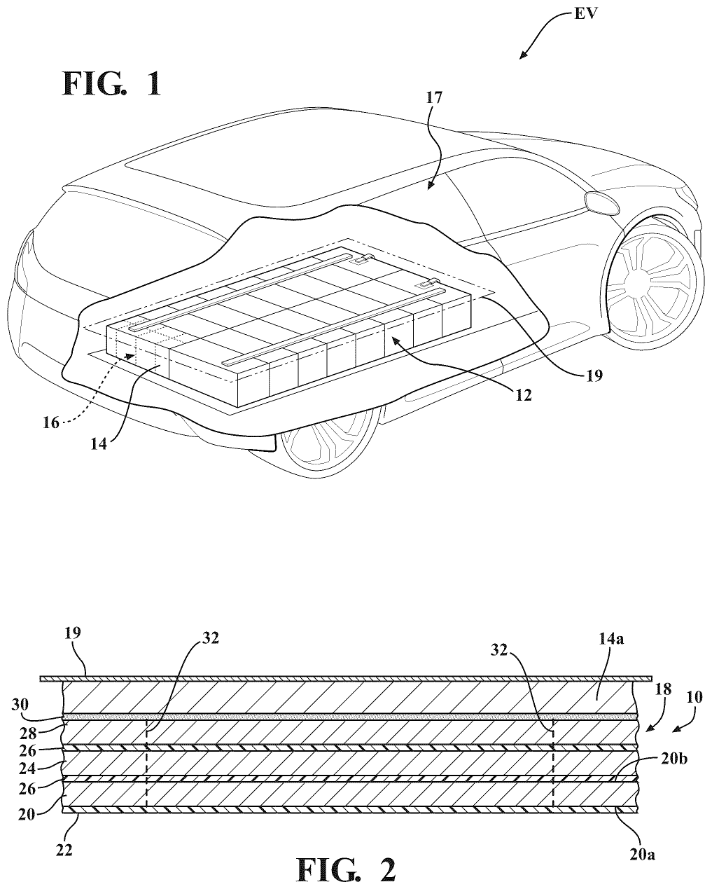

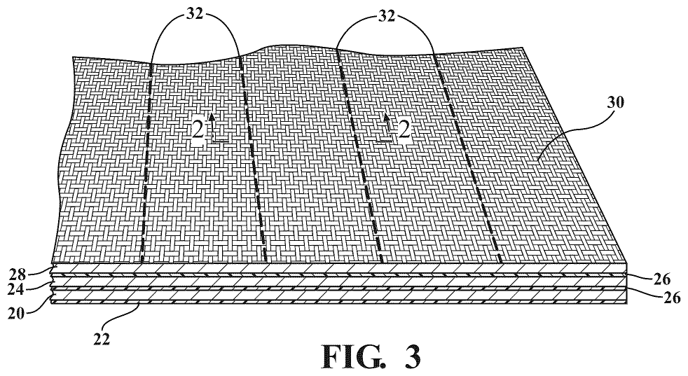

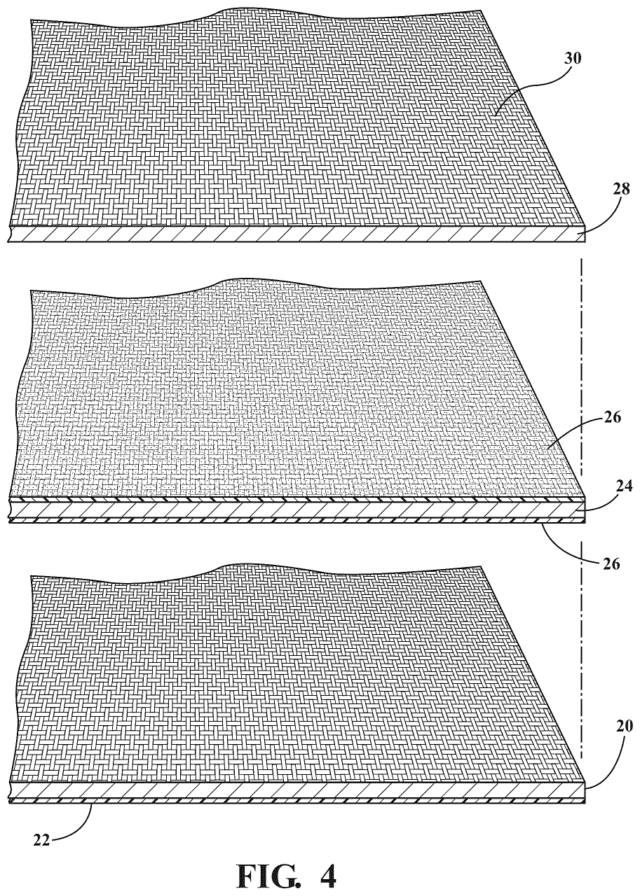

Referring in more detail to the drawings, FIG. 1 illustrates a motor vehicle, shown as an electrically powered motor vehicle, also referred to as electric vehicle EV, having a battery pack 12, such as a lithium-ion battery pack, configured with a flexible multilayer battery pack insulator, referred to hereafter as insulator 10, constructed and shown in accordance with an aspect of the invention, by way of example and without limitation. The electric vehicle battery pack 12 includes a housing member, also referred to as housing or casing 14 bounding a plurality of cells 16 (shown in FIG. 1 in hidden in one cell pack to avoid cluttering the figure), and including bus-bars interconnecting cells, high voltage electrical connectors, cell interfaces, low voltage signal wires, high voltage cables and a cooling system having cooling tubes through which coolant can flow, as is generally known in electric vehicle battery packs. During normal use, and including in non-normal situations, such as in a vehicle crash condition or some other condition causing an impact force to battery pack 12, in contrast to a battery pack 12 not having a multilayer thermal insulator 10 as disclosed herein, a thermal runaway condition originating in any one of the cells 16 of a battery pack 12, with the multilayer thermal insulator 10 being disposed on in inner face of the casing 14 and about the cells 16, as illustrated in a fragmentary view of FIG. 2, is controlled and contained in the battery pack 12 via the multilayer thermal insulator 10, such that flame propagation outwardly from the casing 14 is prevented for at least 10 minutes at an internal cell temperature ranging between 800-1500° C., and an outer surface temperature of the casing 14 is maintained to be less than 500° C. for 5 minutes. Accordingly, passengers within a passenger compartment 17 of the vehicle EV are shielded against exposure to flame and high temperature therefrom, as is any dielectric member 19 along an outer surface of the casing 14, such as a cationic coating, by way of example and without limitation, from erupting into flame. It is to be understood that the insulator 10 can be disposed along an inner surface of an upper case wall 14a, or about any other surfaces, including the entirety of the casing 14, as desired.

The insulator 10 is in the form of a relatively thin, such as having a total thickness between about 1.5 mm to 2.5 mm, and flexible multilayer wall, also referred to as wall 18. The wall 18, being thin and flexible, can be contoured as desired to provide a protective outer barrier about an upper surface of the cells 16, or about the entirety of an outer periphery of the cells 16.

The wall 18, in the non-limiting embodiment illustrated, as best shown schematically in a fragmentary view of FIG. 2 includes a first layer of mineral material, also referred to as an inner layer 20. The mineral material of the inner layer 20 can be formed of interlaced mineral yarns. The mineral yarns of the inner layer 20 can be interlaced in a weaving process to form a tight weave structure using a tight plain weave pattern, by way of example and without limitation. Otherwise, mineral yarns or fibers can be interlaced in a knitting process or intertwined in a nonwoven process. The inner layer 20, upon being assembled to form the wall 18 has an inner surface 20a, forming an innermost surface of the wall 18, and an outer surface 20b, wherein a first flame-resistant coating 22 is bonded to the inner surface 20a. The inner layer 20, in accordance with one non-limiting embodiment, is woven with silica multifilaments, though other materials are contemplated, such as fiberglass, aramid, ceramic, or other mineral materials. The first flame resistant coating 22 is a silicone-based coating, and in one exemplary embodiment is provided as a generally homogenous silicone and mica blend, with the mica acting as a flame retardant and ranging between 1-35% by weight of the first flame-resistant coating blend. The silicone-based coating 22 is very thin, having a thickness between about 0.1-0.9 mm, thereby not adding significantly to the overall thickness of the insulator 10. The silicone-based coating 22 directly faces the cells 16, and thus, if any flame is present from a cell or cells 16, the flame first contacts the silicone-based coating 22, whereupon the silicone within the coating 22 is caused to change phase and turn into silica, which forms a strong flame barrier to block the direct flame from passing through the inner layer 20. The silicone-based coating 22 can be applied having a coating weight between about 50 gsm to 600 gsm, and the first layer 20 can be made having a weight between 100 gsm to 1,200 gsm.

The wall 18 further includes a second layer of mineral material, also referred to as an intermediate layer 24. The mineral material of the intermediate layer 24 can be formed of interlaced mineral yarns or ceramic yarns. The mineral yarns of the intermediate layer 24 can be provided of the same materials as discussed above for the mineral yarns of the first layer 20, and can be interlaced in a weaving process to form a tight weave structure using a tight plain weave pattern, by way of example and without limitation. Otherwise, the mineral yarns or fibers can be interlaced in a knitting process or intertwined in a nonwoven process. The second layer 24 can be made having a weight between 50 gsm to 1,000 gsm.

The wall 18 further includes a third layer of mineral material, also referred to as outer layer 28. The mineral material of the outer layer 28 can be formed of interlaced mineral yarns. The mineral yarns of the outer layer 28 can be provided of the same materials as discussed above for the mineral yarns of the first layer 20, and can be interlaced in a weaving process to form a tight weave structure using a tight plain weave pattern, by way of example and without limitation. Otherwise, the mineral yarns or fibers can be interlaced in a knitting process or intertwined in a nonwoven process. A second flame-resistant coating 26 can be bonded to the third layer 28, wherein the second flame-resistant coating 26 can be provided of the same silicone-based material, including mica, as discussed above for the first flame resistant coating 22. Otherwise, the second flame-resistant coating 26 can be provided solely as a silicone coating. The second flame-resistant coating 26 is shown in FIG. 2 being bonded to an inner surface, facing the second layer 24, of the third layer 28, such that the second flame-resistant coating 26 is sandwiched between the inner surface of the third layer 28 and an outwardly facing surface of the second layer 24.

To facilitate fixing the insulator 10 to the casing 14, the insulator 10 can include an adhesive layer, such as a pressure-sensitive adhesive 30, bonded to an outwardly facing outer surface of the outer layer 28, with the adhesive 30 facing away from the intermediate layer 24 for direct adhesion to the casing 14. To fix all the aforementioned layers 20, 24, 28 to one another, at least one filament 32 is stitched, such as in a quilting process, thereby fixing the outer layer 20, the intermediate layer 24, and the inner layer 28 to one another.

The outer layer 28, in accordance with one non-limiting embodiment, is woven to form a low gsm mineral fabric to facilitate adhesion of the pressure-sensitive adhesive 30 thereon, and in accordance with one non-limiting embodiment, is woven with fiberglass multifilaments.

The pressure-sensitive adhesive layer 30 faces outwardly from the outer layer 28, such that the pressure-sensitive adhesive layer 30 can be exposed for adhesion to an inner surface of the casing 14, thereby orienting the first flame resistant coating 22 to directly face the cells 16. The pressure sensitive adhesive layer 30 is the only adhesive layer of the insulator 10, thereby minimizing the amount of fuel for flame. The pressure-sensitive adhesive layer 30 can be provided as an acrylic material, thereby being heat-resistant. Prior to use and application, the pressure-sensitive adhesive layer 30 can be covered and protected by a release layer, wherein the release layer is selectively removed from the pressure sensitive adhesive layer 30 for use, when desired.

The filament 32, such as a polymer, e.g. nylon thread, or a mineral yarn, such as fiberglass, nomex, aramid filament, coated with polytetrafluoroethylene (PTFE) or silica, by way of example and without limitation, is stitched in a quilting process to fix the inner layer 20, the intermediate layer 24, and the outer layer 28 to one another. To avoid contaminating stitching needles during quilting, the pressure sensitive adhesive layer 30 is preferably applied to the outer layer 28 after the quilting is completed, along with the release layer, if desired. Then, the quilted wall 18 can be cut to size. The quilted wall 18 allows the individual layers 20, 24, 28 to shift relative to one another between stitched filaments, thereby reducing conduction of heat, with air layers between the layers 20, 24, 28 further insulating against the transfer of heat through the insulator 10.

In accordance with another aspect, a method of constructing a flexible multilayer battery pack insulator 10 includes: interlacing mineral yarns or fibers to form an inner layer 20 having an inner surface 20a and an outer surface 20b. Further, bonding a first flame-resistant coating 22, as discussed above, at least to the inner surface 20a of the inner layer 20. Further, interlacing mineral yarns or fibers to form an intermediate layer 24. Further, interlacing mineral yarns or fibers to form an outer layer 28. Further, arranging the intermediate layer 24 between the inner layer 20 and the outer layer 28, and then, stitching at least one filament 32 and fixing the inner layer 20, the intermediate layer 24, and the outer layer 28 to one another to form a multilayer wall 18. Then, bonding a pressure-sensitive adhesive 30 to the outer layer 28, and cutting the multilayer wall 18 to size.

The method further includes leaving the outer layer 20, the intermediate layer 24, and the inner layer 28 in detached relation from one another other than where the outer layer 20, the intermediate layer 24, and the inner layer 28 are stitched together by the at least one filament 32. The stitching process can include stitching the outer layer 20, the intermediate layer 24, and the inner layer 28 via a plurality of filaments 32, with each of the plurality of filaments 32 being spaced from one another to allow relative movement of the outer layer 20, the intermediate layer 24, and the inner layer 28 between the stitched filaments 32. The stitching process further includes forming air pockets between the stitched filaments 32 to enhance thermal insulation properties of the insulator 10.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A flexible multilayer battery pack insulator for an electric vehicle, comprising:
a multilayer wall including:
a plurality of layers, said plurality of layers including an inner layer of mineral material having an inner surface and an outer surface, and an outer layer of mineral material having an inner surface and an outer surface;
at least one flame-resistant coating, the at least one flame-resistant coating including a first flame resistant coating of silicone and mica, the first flame-resistant coating bonded to at least one of said plurality of layers;
an adhesive layer bonded to said outer surface of said outer layer; and
at least one filament fixing said plurality of layers to one another.

2. The flexible multilayer battery pack insulator of claim 1, wherein the first flame-resistant coating is bonded to said inner surface of said inner layer.

3. The flexible multilayer battery pack insulator of claim 2, wherein said plurality of layers includes an intermediate layer of mineral material disposed between said outer layer and said inner layer.

4. The flexible multilayer battery pack insulator of claim 3, wherein the at least one flame-resistant coating includes a second flame-resistant coating bonded to said intermediate layer.

5. The flexible multilayer battery pack insulator of claim 3, wherein said mineral material of said outer layer includes interlaced mineral yarns of silica.

6. The flexible multilayer battery pack insulator of claim 5, wherein said mineral material of said intermediate layer includes interlaced mineral yarns of ceramic.

7. The flexible multilayer battery pack insulator of claim 6, wherein said mineral material of said inner layer includes interlaced mineral yarns of fiberglass.

8. The flexible multilayer battery pack insulator of claim 3, wherein said outer layer, said intermediate layer, and said inner layer are not bonded to one another with an adhesive material.

9. The flexible multilayer battery pack insulator of claim 1, wherein said adhesive layer is the only adhesive layer of said multilayer wall.

10. The flexible multilayer battery pack insulator of claim 1, wherein the mica ranges between 1-35% by weight in the at least one flame-resistant coating.

11. A flexible multilayer battery pack insulator for an electric vehicle, comprising:
a multilayer wall including:
an inner layer of mineral material, said inner layer having an outer surface and an inner surface;
a first flame-resistant coating including a blend of silicone and mica bonded to said inner surface of said inner layer;
an intermediate layer of mineral material;
an outer layer of mineral material, said intermediate layer disposed between said outer layer and said inner layer;
a pressure-sensitive adhesive layer bonded to said outer layer, said pressure-sensitive adhesive facing away from said intermediate layer; and
at least one filament fixing said outer layer, said intermediate layer, and said inner layer to one another.

12. The flexible multilayer battery pack insulator of claim 11, wherein said mineral material of at least one of said inner layer, said intermediate layer, and said outer layer includes interlaced mineral yarns.

13. The flexible multilayer battery pack insulator of claim 11, wherein said mineral material of each of said inner layer, intermediate layer, and outer layer includes interlaced mineral yarns.

14. The flexible multilayer battery pack insulator of claim 12, wherein said interlaced mineral yarns are woven or knitted.

15. The flexible multilayer battery pack insulator of claim 11, wherein said outer layer, said intermediate layer, and said inner layer are not bonded to one another with an adhesive material.

16. The flexible multilayer battery pack insulator of claim 11, wherein said pressure-sensitive adhesive layer is the only adhesive layer of said multilayer wall.

17. The flexible multilayer battery pack insulator of claim 11, wherein the mica ranges between 1-35% by weight in the first flame-resistant coating.

18. The flexible multilayer battery pack insulator of claim 11, wherein the inner layer has a weight between 100 gsm to 1,200 gsm and the intermediate layer has a weight between 50 gsm to 1,000 gsm.

19. The flexible multilayer battery pack insulator of claim 11, further including a second flame-resistant coating sandwiched between the outer layer and the intermediate layer.

20. A method of constructing a flexible multilayer battery pack insulator, comprising:
interlacing mineral material to form an inner layer having an outer surface and an inner surface;
bonding a first flame-resistant coating to the inner surface of the inner layer;
interlacing mineral material to form an intermediate layer;
interlacing mineral material to form an outer layer;
arranging the intermediate layer between the inner layer and the outer layer;
stitching at least one filament and fixing the inner layer, the intermediate layer, and the outer layer to one another to form a multilayer wall;
bonding a pressure-sensitive adhesive to the outer layer; and
cutting the multilayer wall to size.
